(19) United States
(12) Patent Application Publication
(10) Pub. No.: US 2026/0257145 A1
(43) Pub. Date: Sep. 3, 2026

(54) THERMAL DESALINATION SYSTEM

(71) Applicants: Research Foundation of the City University of New York, New York, NY (US); Sun Fresh Water, LLC, Ormond Beach, FL (US)

(72) Inventors: Ali M. Sadegh, Franklin Lakes, NJ (US); Jorge E. Gonzalez-Cruz, Altamont, NY (US); Joseph James D'Alba, Ormond Beach, FL (US); George Victor St. Pierre, Ormond Beach, FL (US); George Farinick, Ormond Beach, FL (US)

(21) Appl. No.: 18/994,833

(22) PCT Filed: Jul. 14, 2023
(86) PCT No.: PCT/US23/70235

§ 371 Date: Jan. 15, 2025

Related U.S. Application Data
(60) Provisional application No. 63/389,678, filed on Jul. 15, 2022.
(60) Provisional application No. 63/401,874, filed on Aug. 29, 2022.
(60) Provisional application No. 63/488,636, filed on Mar. 6, 2023.
(60) Provisional application No. 63/503,086, filed on May 18, 2023.

(51) Int. Cl. B01D 1/00; B01D 3/20; B01D 5/00; C02F 1/14; C02F 1/16; C02F 103/00; C02F 103/08

(52) U.S. Cl. CPC B01D 1/0047; B01D 1/0035; B01D 1/0058; B01D 3/205; B01D 5/006; C02F 1/14; C02F 1/16; C02F 2103/007; C02F 2103/08

(57) ABSTRACT

A thermal desalination system connected to a heat source, such as a power plant that generates waste heat, that produces a heated liquid. The heated liquid is routed to a heat exchanger and/or a desalination device before being returned to the heat source. When present, the heat exchanger preheats water for subsequent purification by distillation, thereby producing potable water.

### CROSS-REFERENCE TO RELATED APPLICATIONS

This application claims priority to, and is a non-provisional of, U.S. Patent Applications 63/389,678 (filed July 15, 2022); 63/401,874 (filed August 29, 2022), 63/488,636 (filed March 6, 2023) and 63/503,086 (filed May 18, 2023), the entirety of which is incorporated herein by reference.

### BACKGROUND OF THE INVENTION

The subject matter disclosed herein relates to methods and devices for producing potable water. Scarcity of potable water is a serious threat. This threat is readily apparent in almost every region of the world from the Middle East, Africa, Europe, Asia, Australia and the Americas. Worldwide, two billion people lack access to clean water and climate change is likely to increase the frequency of weather events that will further exacerbate this problem.

While some attempts have been made to produce systems that can purify water, none of these solutions has been entirely successful. Expense, scalability and environmental sustainability remain concerns for these systems. An improved method an device is therefore desired.

The discussion above is merely provided for general background information and is not intended to be used as an aid in determining the scope of the claimed subject matter.

### SUMMARY

This disclosure provides a thermal desalination system connected to a heat source, such as a power plant that generates waste heat, that produces a heated liquid. The heated liquid is routed to a heat exchanger and/or a desalination device before being returned to the heat source. When present, the heat exchanger preheats water for subsequent purification by distillation, thereby producing potable water.

In a first embodiment, a thermal desalination system is provided. The thermal desalination system comprising: a heat source that heats a substance to produce a heated liquid; a fluid path for transferring the heated liquid to a desalination device configured to receive the heated liquid; a return path for transferring the heated liquid from the desalination device to the heat source; a raw water source with raw water, a raw water line that transfers the raw water from the raw water source to the desalination device, the desalination device configured to distill the raw water using heat from the heated liquid, thereby producing potable water; and a potable water tank for storing the potable water

In a second embodiment, a thermal desalination system is provided. The thermal desalination system comprising: a heat source that heats a substance to produce a heated liquid; a fluid path for transferring the heated liquid to a heat exchanger configured to receive the heated liquid; a return path for transferring the heated liquid from the heat exchanger to the heat source; a raw water source with raw water, a raw water line that transfers the raw water from the raw water source to the heat exchanger, the heat exchanger configured to heat the raw water using heat from the heated liquid, thereby producing heated raw water, a desalination device that receives the heated raw water and desalinate the heated raw water by distillation to produce potable water; and a potable water tank for storing the potable water.

In a third embodiment, a thermal desalination system is provided. The thermal desalination system comprising: a heat source that heats a substance to produce a heated liquid; a fluid path for transferring the heated liquid to (1) a heat exchanger configured to receive the heated liquid and (2) a desalination device configured to receive the heated liquid; a return path for transferring the heated liquid from the heat exchanger and the desalination device to the heat source; a raw water source with raw water; a raw water line that transfers the raw water from the raw water source to the heat exchanger, the heat exchanger configured to heat the raw water using heat from the heated liquid, thereby producing heated raw water; the desalination device configured to receive the heated raw water and desalinate the heated raw water by distillation, using the heat from the heated liquid, to produce potable water, and a potable water tank for storing the potable water.

This brief description of the invention is intended only to provide a brief overview of subject matter disclosed herein according to one or more illustrative embodiments, and does not serve as a guide to interpreting the claims or to define or limit the scope of the invention, which is defined only by the appended claims. This brief description is provided to introduce an illustrative selection of concepts in a simplified form that are further described below in the detailed description. This brief description is not intended to identify key features or essential features of the claimed subject matter, nor is it intended to be used as an aid in determining the scope of the claimed subject matter. The claimed subject matter is not limited to implementations that solve any or all disadvantages noted in the background.

### BRIEF DESCRIPTION OF THE DRAWINGS

So that the manner in which the features of the invention can be understood, a detailed description of the invention may be had by reference to certain embodiments, some of which are illustrated in the accompanying drawings. It is to be noted, however, that the drawings illustrate only certain embodiments of this invention and are therefore not to be considered limiting of its scope, for the scope of the invention encompasses other equally effective embodiments. The drawings are not necessarily to scale, emphasis generally being placed upon illustrating the features of certain embodiments of the invention. In the drawings, like numerals are used to indicate like parts throughout the various views. Thus, for further understanding of the invention, reference can be made to the following detailed description, read in connection with the drawings in which:

FIG. 1A is a schematic depiction of one thermal desalination system.

FIG. 1B is a schematic depiction of another thermal desalination system.

FIG. 1C is a schematic depiction of yet another thermal desalination system.

FIG. 2 depicts a solar heat source for use with a thermal desalination system.

FIG. 3A, FIG. 3B and FIG. 3C are depictions of a desalination device for use with a thermal desalination system.

FIG. 4A and FIG. 4B provide a top plan view and a side plan view of the desalination device of FIGS. 3A-3C.

FIG. 5A and FIG. SB are depictions of two gutter configurations for use with a desalination device.

FIG. 6A is a schematic of an array of desalination devices.

FIG. 6B is a schematic showing an array of vertically stacked desalination devices.

FIG. 7 is a depiction of a thermal desalination tower or use with a thermal desalination system.

FIG. 8 depicts a lower heating portion of the thermal desalination tower.

FIG. 9 is another depiction of the lower heating portion of the thermal desalination tower.

FIG. 10 illustrates an upper distillation portion of the thermal desalination tower.

FIG. 11 is a top plan view of thermal desalination tower showing an interior.

FIG. 12A and FIG. 12B are side and top views, respectively, of a bubble cap tray for use with the thermal desalination tower.

### DETAILED DESCRIPTION OF THE INVENTION

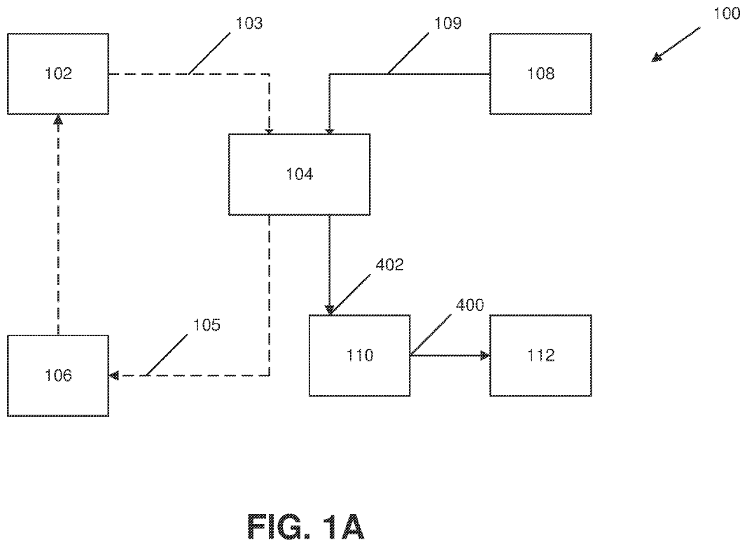

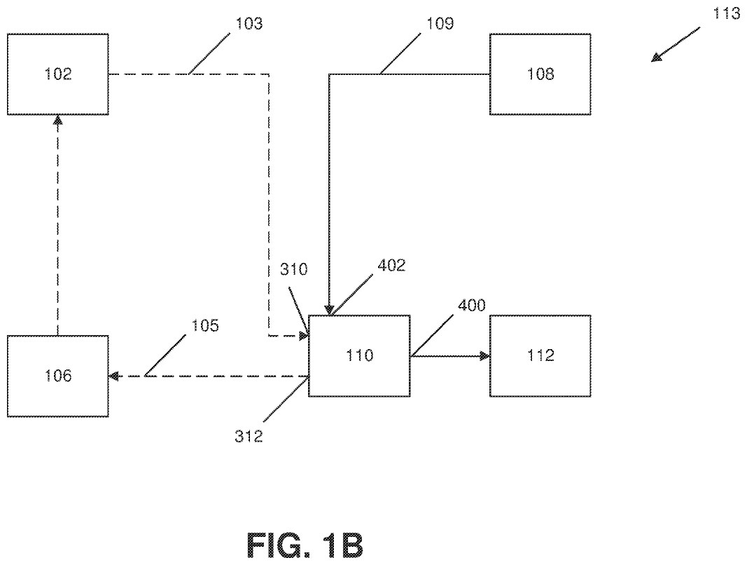

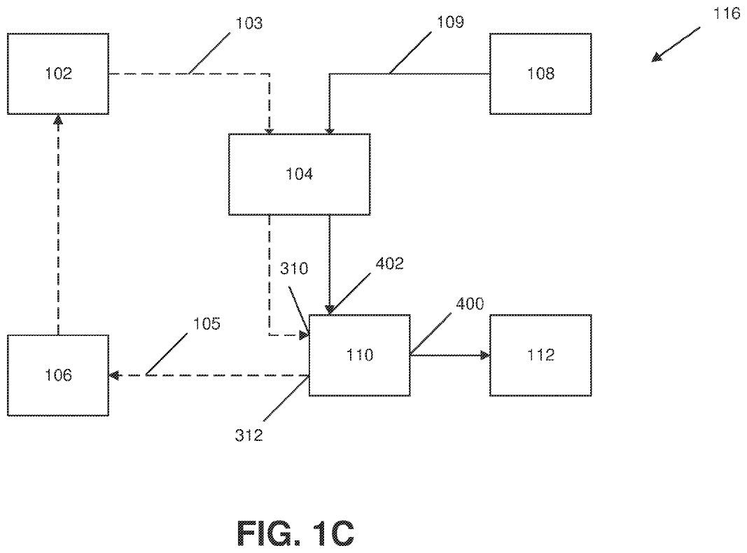

FIG. 1A depicts a thermal desalination system 100. A heat source 102 provides thermal energy to heat a substance (e.g. water, oil, salt, etc.) to produce a heated liquid (e.g. heated water, oil, molten salt, etc.) in a fluid path 103. The liquid may be heated (e.g. to a temperature greater than ambient temperature) or superheated (e.g. at a temperature greater than 189° C.). Further examples of suitable temperatures include greater than 50° C., greater than 70° C. and greater than 90° C. In one embodiment, the heat source 102 is a solar heat source that heats a liquid using solar power. In another embodiment, heat source 102 is a power facility, such as a gas turbine, coal, oil or nuclear power facility. In one such embodiment, the power facility is a Concentrated Solar Power (CSP) facility that produces molten salt. During operation, a power facility produces waste heat. Traditionally, this waste heat is absorbed by a cooling liquid (e.g. water) that is circulated through the fluid path 103. The hot liquid is transferred to a liquid holding tank 106 where it is allowed to cool. After reaching a predetermined temperature, the water is returned to the power facility through a return path 105 for subsequent re-use as a cooling liquid.

In the embodiment of FIG. 1A, a heat exchanger 104 is present in-line with the fluid path 103 such that the heat from the heat source 102 is used to pre-heat raw water from a raw water source 108. The raw water source may be a tank of raw water (e.g. salt water) or may be a body of water such as a lake or an ocean, Raw water 108 is transferred to the heat exchanger 104 by a raw water line 109. The heat exchanger 104 pre-heats the raw water before it is provided to a desalination device 110. The desalination device 110 desalinates the raw water by distillation with purified water being stored in a potable water tank 112. In some embodiments, a cooling device (e.g. radiator with fins) or cooling tank is present in-line between the heat source 102 and the heat exchanger 104 to cool the heated liquid to an acceptable temperature. Such an embodiment is particularly useful when the heat source 102 is a concentrated solar power facility that is producing molten salt.

FIG. 1B depicts a thermal desalination system 114 that is similar to the thermal desalination system 100 except in that the heated liquid in the fluid path 103 is not used to pre-heat the raw water with a heat exchanger. Instead, the heated liquid in the fluid path 103 is used to boil water in the desalination device 110.

FIG. 1C depicts a thermal desalination system 116 that is similar to the thermal desalination systems 100, 114 except in that the heated liquid in the fluid path 103 is both used to pre-heat the raw water with the heat exchanger 104 and is also used by the desalination device 110 to boil water. Like the embodiment of FIG. 1A, a cooling device (e.g. radiator with fins) or cooling tank is present line between the heat source 102 and the heat exchanger 104 and/or the desalination device 110 to cool the heated liquid to an acceptable temperature.

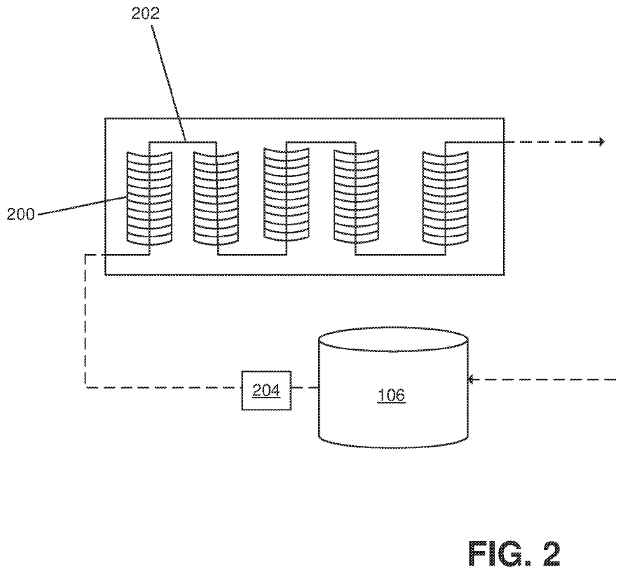

FIG. 2 depicts an embodiment wherein the heat source 102 is a solar heat source that heats a liquid using solar power. In one embodiment, the solar heat source comprises a mechanized sun tracking system and/or one or more mirrors 200, such as linear parabolic mirrors. The mirrors 200 focus the sun's rays on a piping system 202 to heat the liquid. In one embodiment, the piping system is a serpentine piping system. The liquid is then circulated through the heat exchanger 104 and/or the desalination device 110. Once used, the liquid is returned to the liquid holding tank 106 for subsequent re-use. A pump 204 re-introduces the liquid to the heat source 102. Any need for electric power (e.g. to power the pump 204) may be provided by photovoltaic cells and/or electric storage batteries and regulators. In another embodiment, the electrical power is alternating current (AC) or direct current (DC) power that is generated from a powerplant, such as a gas turbine, coal or nuclear power plant.

In one embodiment, the desalination device 110 is a solar desalination device such as those described in U.S. Pat. Nos. 10,150,049 and 10,150,050, the contents of which are hereby incorporated by reference.

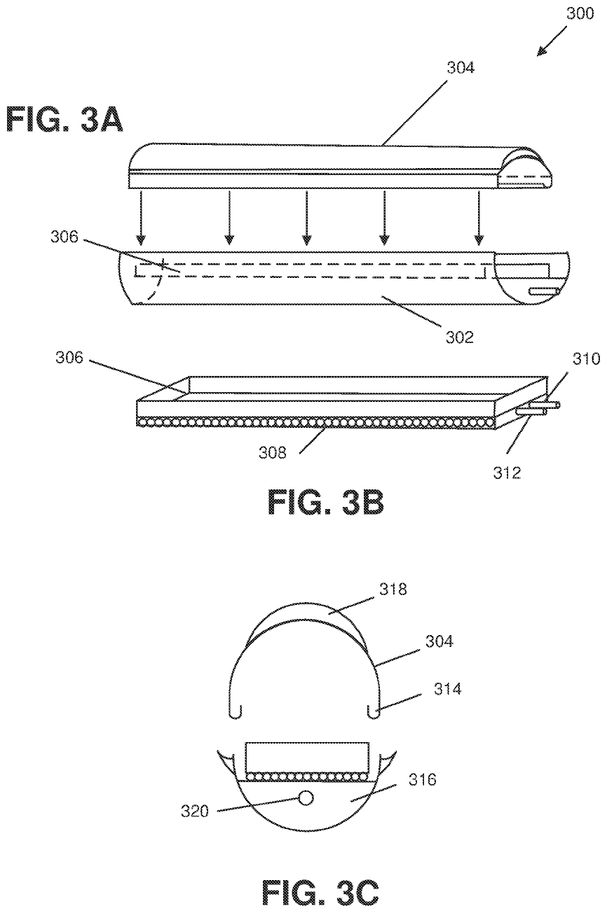

FIG. 3A is a schematic depiction of another desalination device 300. The desalination device 300 is divided into a top half 304 (which, in FIG. 3A, is an opaque half cylinder) and a bottom half 302, with each half being removably connected to the other. This allows a user to easily clean the desalination device 300. In one embodiment, the desalination device 300 is constructed from an opaque, corrosion resistant metal such as stainless steel. As shown in FIG. 3B, the desalination device 300 comprises an evaporation pan 306 that has heating coils 308 under its lower surface. The heating coils 308 receive the heated liquid from fluid path 103 at a fluid input 310. The heated liquid is then passed through the heating coils 308 which heats any raw water that is present in the evaporation pan 306. The heated liquid then exits the heating coils 308 at a fluid output 312. In another embodiment, the heating coil 308 are electric heating coils powered by photovoltaic power or wind power.

Referring to FIG. 3C, the desalination device 300 includes a gutter 314. In the embodiment of FIG. 3C, the gutter 314 is contiguous with the top half 304. The gutter 314 traverses the length of the top half 304 and is located at its interior, terminal edges. Condensed water is caught in the gutter 314 and is carried laterally to one end of the desalination device 300 by gravity. The gutter 314 is disposed at a slight angle such that water runs toward one end of the desalination device 300. This angled configuration promotes water collection. In one embodiment, the gutter 314 is angled from the horizontal by an angle θ which is greater than 0° and less than 80°. In one embodiment, the angle θ is greater than 0° but less than 20°. In one embodiment, the angle θ is between 10°and 70°. In another embodiment, the angle θ is between 30° and 60°. In another embodiment, the angle θ is between 35° and 50°.

In the embodiment of FIG. 3C, the bottom half 302 has an evacuated base 316 (air removed using port 320) that helps to thermally insulate the heating coils 308. In the embodiment depicted in the figures, the bottom half 302 is a bisected cylinder that has been bisected along its longitudinal axis. In other embodiments, the bottom half 302 is a different shape, such as rectangular, that has a flat bottom surface.

In one embodiment, the top half 304 includes a cooling mechanism to enhance condensation. In one embodiment, cool air is blown through a hollow tube 318 by a fan to enhance the rate of cooling. In such an embodiment, the hollow tube 318 is open on both ends to permit air flow. In another embodiment, the air temperature may also be cooled with an air conditioning device. In such an embodiment, the hollow tube 318 is sealed such that the cooled air is recirculated. Liquid water, such as deionized water containing a nanoparticle suspension (e.g. NANOCOOL™) may be used in the hollow tube 318 to cool the top half 304. In such an embodiment, the nanoparticle suspension may be cooled via photovoltaics or electric powered refrigeration system. Electricity from the power facility may be used to power such a system. In one embodiment, the hollow tube 318 is a hollow tube that covers at least 50% of the top surface of the top half 304.

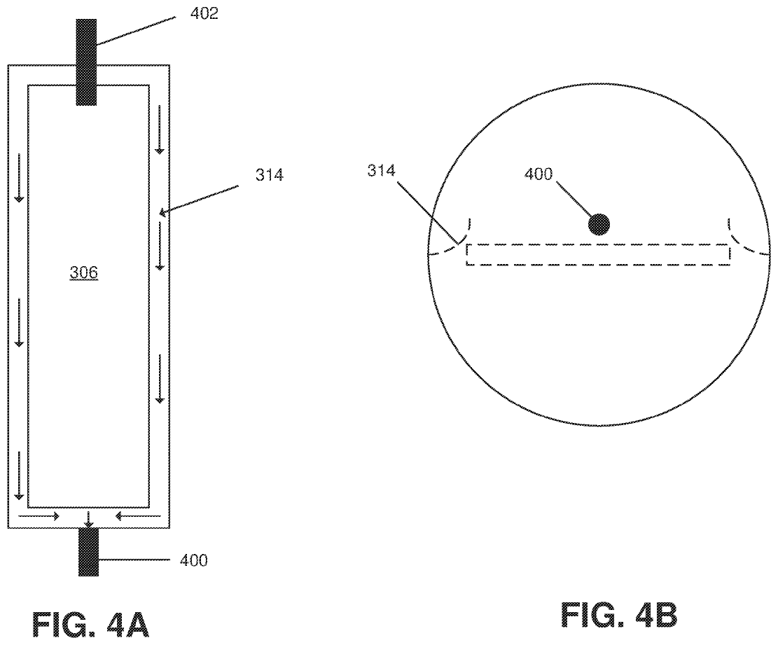

FIG. 4A depicts the gutter 314 from a top plan view. The gutter 314 circumscribes the evaporation pan 306. Raw water is introduced to the evaporation pan 306 through raw water input port 402 which, in turn, is fluidly connected to the raw water source 108. After evaporation and condensation, the gutter 314 transfers the distilled water to distilled water output port 400. FIG. 4B shows an end plan view from the direction facing the distilled water output port 400.

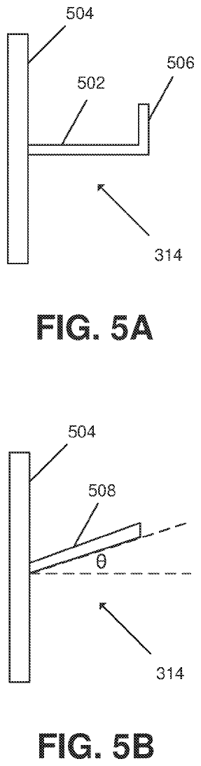

FIG. 5A and FIG. 5B provide two alternative depictions of the gutter 314. In the embodiment of FIG. 5A, the gutter 314 comprises a bottom shelf 502 that extends perpendicular from a sidewall 504 of the desalination device 300. The gutter 314 of FIG. 5A further comprises a vertical lip 506 at the distal end of the bottom shelf 502. In FIG. 5A the transition between the bottom shelf 502 and the vertical lip 506 is a 90° transition. In another embodiment, the transition is gradual curve.

In the embodiment of FIG. 5B, the gutter 314 comprises an angled bottom shelf 508 that extends at a non-perpendicular angle θ from the vertical sidewall 504. In one embodiment, the angle θ is between 1° and 70°. In another embodiment, the angle θ is between 10° and 60°. In another embodiment, the angle θ is between 35° and 50°.

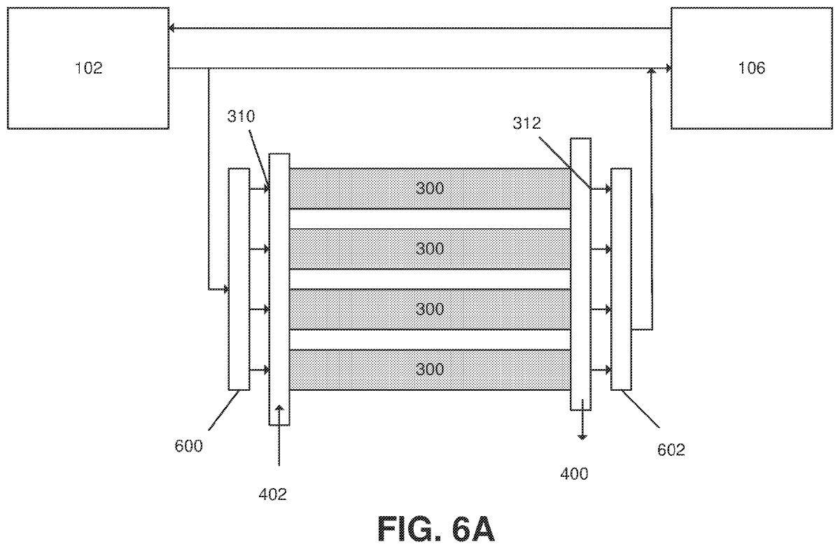

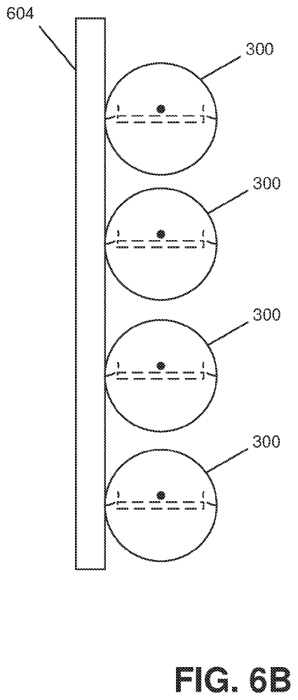

Referring to FIG. 6A, an array comprising multiple desalination devices 300 arranged in parallel is shown. Heated liquid enters an inlet manifold 600 and is thereafter routed to individual desalination devices 300 to heat the evaporation pan therein. The heated liquid exits at an outlet manifold 602 before being routed to the liquid holding tank 106. In those embodiments where each desalination devices 300 is in parallel, each such device can be removed for servicing while the other devices remain functioning.

In those embodiments where the desalination device 300 is not heated by the sun (e.g. wherein the heat source 102 is providing the energy for evaporation), the desalination device 300 may comprise an array of desalination devices 300 that are vertically stacked to reduce their footprint. As shown in FIG. 6B, each of the desalination device 300 is vertically mounted on a rack 600. This configuration is possible because the heating source is the heated liquid and is not direct solar energy (which would require the area above the desalination device 300 to be unobstructed).

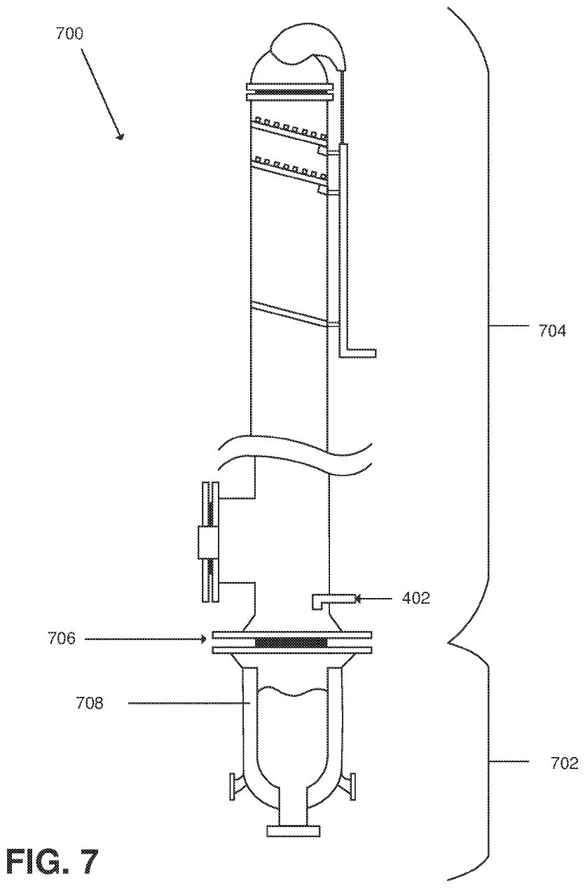

FIG. 7 depicts an embodiment wherein the desalination device 110 is a thermal desalination tower 700. The thermal desalination tower receives raw water from the raw water source 108 via raw water input port 402. The thermal desalination tower 700 comprises a lower heating portion 702 and an upper distillation portion 704 that are removably connected to one another by flange-seal 706. The desalination tower 700 can be of variable size dependent upon need and location. In one embodiment, the thermal desalination tower 700 is between ten feet and fifteen feet in height. The raw water in the thermal desalination tower 700 is heated with a hot liquid jacket 708 that received hot liquid from the heat source 102.

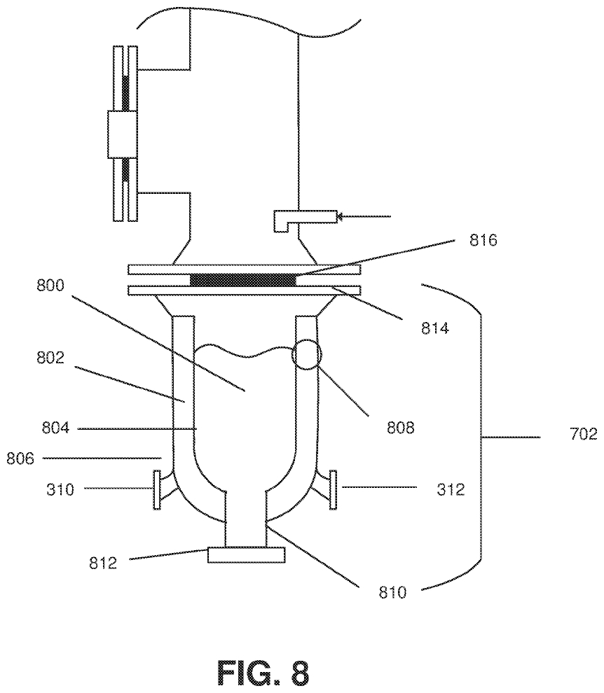

Referring to FIG. 8, the lower heating portion 702 comprises a hollow cavity 800 for receiving raw water from the raw water source 108. The hot liquid jacket 708 comprises a double-walled chamber 802 that is disposed about the hollow cavity 800. The double-walled chamber 802 surrounds the hollow cavity 800 on all sides except for a top opening. The double-walled chamber 802 comprises an inner wall 804, an outer wall 806, the fluid input 310 and the fluid output 312. In the embodiment of FIG. 8, the fluid input 310 and the fluid output 312 are disposed at the same height. In another embodiment, the fluid output 312 is disposed above the fluid input 310 (e.g. a location 808). In use, the heated liquid is introduced into the double-walled chamber 802 through the fluid input 310. The heated liquid partially or completely fills the double-walled chamber 802, and then exits through the fluid output 312 for subsequent reuse. The heated substance heats the raw water in the hollow cavity 800 and thereby enables distillation of the raw water. A lower access port 810 with a valve 812 is present at the bottom of the lower heating portion 702. The lower access port 810 permits access to the hollow cavity 800 to enable cleaning, including the removal of residual salt.

A flange 814 is present with a seal 816 that is configured to removably connect the lower heating portion 702 to the upper distillation portion 704. In one embodiment, the seal 816 is formed of a food-grade silicone material. In one embodiment, the seal 816 is an o-ring. The double-walled chamber 802 may also be equipped with one or more pressure relief valves (not shown) to control the maximum pressure.

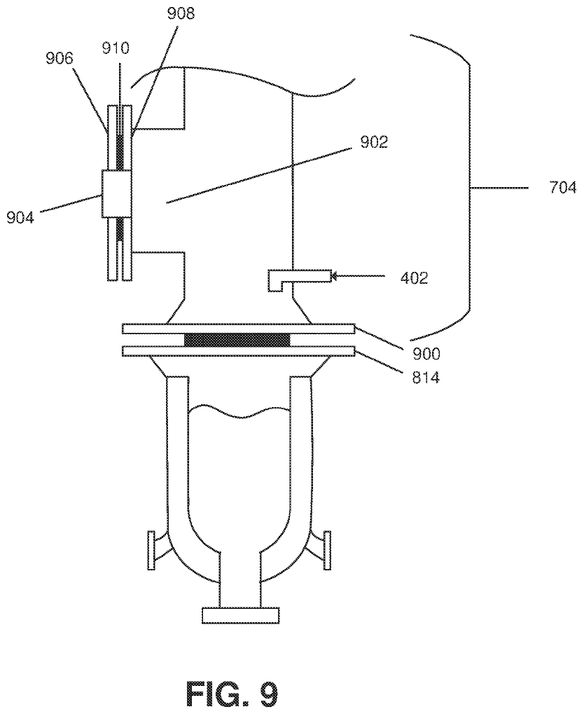

FIG. 9 details a lower end of the upper distillation portion 704. The upper distillation portion 704 comprises a flange 900 that is configured to mate with the flange 814. The flanges 900, 814 may be securely connected to one another with clamps or bolts (not shown). The upper distillation portion 704 includes a manway 902 with an optically transparent observation port 904. A user can see inside the upper distillation portion 704 and such a configuration lets the user verify the raw water is at a proper level, In one embodiment, the observation port 904 is removably connected to the upper distillation portion 704 with flanges 906, 908 and a seal 910 (which is similar to seal 816). Removal of the observation port 904 permits the user to have an additional access pathway for cleaning. The raw water inlet port 402 receives water from the water source 402 and relays the water to the hollow cavity 800. The raw water inlet port 402 is disposed proximate the bottom of the upper distillation portion 704 such that condensation occurs above the raw water inlet port 402.

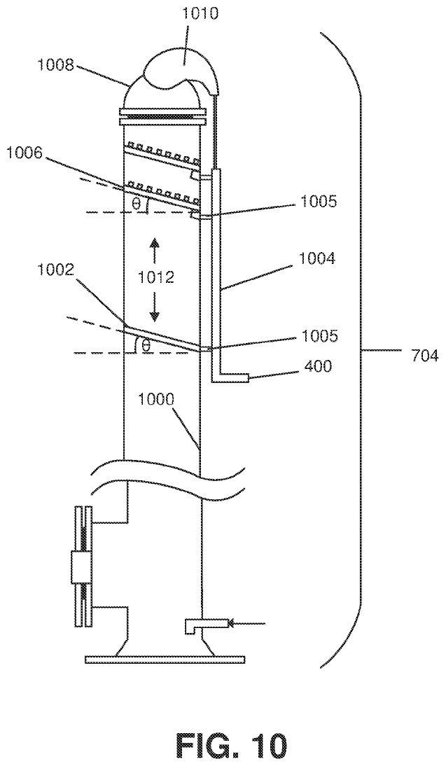

FIG. 10 details an upper end of the upper distillation portion 704. In use, water vapor from the hollow cavity 800 rises and condenses on interior surfaces of the upper distillation portion 704. One such interior surface is a vertical sidewall 1000 of the upper distillation portion 704 which, in the embodiment of FIG. 10, is a cylinder. Condensed water droplets are then collected in a gutter 1002 which directly contacts the vertical sidewall 1000. An outlet manifold 1004 passes distilled water to the distilled water outlet port 400. In one embodiment, the outlet manifold 1004 comprises one or more one-way valves 1005. In one embodiment, one gutter 1002 is present and is proximate the bottom (e.g. within the lower 50% of its height or within the lower 25% of its height) of the upper distillation portion 704 but above the distilled water outlet port 400. In another embodiment, multiple gutters 1002 (e.g. from two to five gutters) are present.

Referring again to FIG. 10, one or more bubble cap trays 1006 are present along a central path 1012, each of which conveys distilled water to the distilled water output port 400. Like the gutter 1002, the bubble cap tray 1006 is angled from horizontal by an angle θ which is greater than 0° and less than 80°. This angled configuration promotes water collection. In one embodiment, the angle θ is between 10° and 70°. In another embodiment, the angle θ is between 30° and 60°. In another embodiment, the angle θ is between 35° and 50°. A variety of bubble cap configurations are known to those skilled in the art.

The distillation portion 704 terminates in a dome 1008 with a hood 1010. The hood 1010 extends horizontally to clear the vertical sidewall 1000 and then gradually curves download while simultaneously narrowing to form a funnel shape. The narrow end of the funnel shape fluidly connects to the outlet manifold 1004. In use, distilled water vapor that is not condensed in the bubble cap tray 1006 and/or gutter 1002 is collected by the hood 1010 and routed to the distilled water outlet port 400. The resulting distilled water may be stored in the potable water storage tank 112 (see FIG. 1B) for subsequent use.

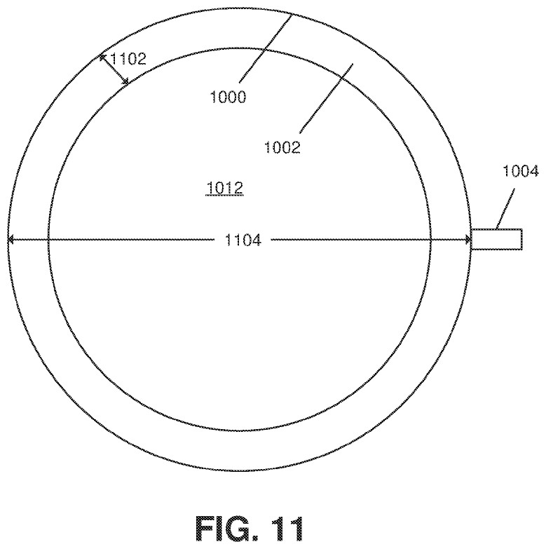

FIG. 11 is a top plan view that depicts the gutter 1002 in further detail. The gutter 1002 extends from the vertical sidewall 1000 by a width 1102. In one embodiment, the width 1102 is between 5% and 30% of the diameter 1104 of the upper distillation portion 704. Like gutter 312, the gutter 1002 may be angled from the horizontal and may have a vertical lip.

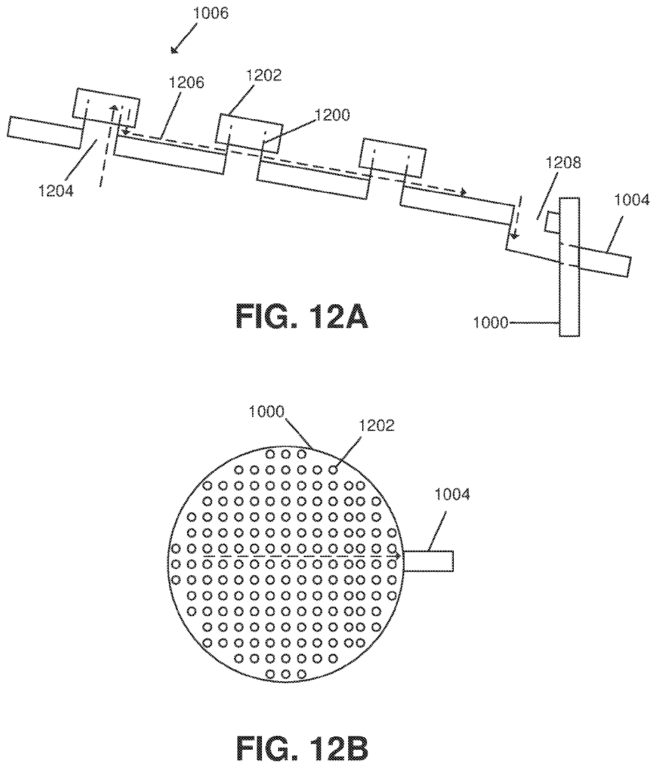

Referring to FIG. 12A and FIG. 12B, one embodiment of a bubble cap tray 1006 is depicted. Each bubble cap in the bubble cap tray 1006 comprises a riser 1200 and a cap 1202. In use, water vapor travels through a hole 1204 in the bubble cap tray 1006 that is defined by the riser 1200. The water vapor contacts the cap 1202 which provides a large surface area for condensation, Condensed water travels on the surface of the bubble cap tray 1006 in the direction of arrow 1206. The risers 1200 prevent the condensed water from passing through the holes 1204 of the other bubble caps. When the condensed water reaches hole 1208 (which is not a bubble cap and is free of the riser 1200) it passes through the bubble cap tray 1006 where it is collected by the outlet manifold 1004. In one embodiment, the outlet manifold 1003 feeds to a single distilled water outlet port 400. The bubble cap tray 1006 of FIG. 12A is merely one example of a bubble cap system. Alternative bubble cap systems would be apparent to one of ordinary skill in the art after having benefitted from reading this specification and such alternative systems are considered within the scope of this invention. FIG. 12B is a top view of the bubble cap tray 1006 of FIG. 12A.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

1. A thermal desalination system comprising:
a heat source that heats a substance to produce a heated liquid;
a fluid path for transferring the heated liquid to a thermal desalination tower configured to receive the heated liquid;
a return path for transferring the heated liquid from the thermal desalination tower to the heat source;
a raw water source with raw water;
a raw water line that transfers the raw water from the raw water source to the thermal desalination tower, the thermal desalination tower configured to distill the raw water using heat from the heated liquid, thereby producing potable water;
a potable water tank for storing the potable water; and
the thermal desalination tower comprising a lower distillation portion comprising:
a hot liquid jacket with a double-walled chamber that is disposed about a hollow cavity, the raw water being transferred to the hollow cavity through a raw water input port, the heated liquid entering the double-walled chamber through a fluid input and exiting through a fluid output, thereby heating the raw water in the hollow cavity to produce vaporized water;
an interior surface for condensing the vaporized water, thereby producing distilled water; and
at least one gutter disposed within the thermal desalination tower such that the at least one gutter receives the distilled water from the interior surface.

2. The thermal desalination system as recited in claim 1, wherein the fluid path transfers the heated liquid to a fluid input of the thermal desalination tower such that the heated liquid circulates through a heating coil of the thermal desalination tower and out of a fluid output before being returned to the heat source.

3. (canceled)

4. (canceled)

5. The thermal desalination system as recited in claim 1, wherein the at least one gutter is disposed at an angle θ from horizontal which is greater than 0° and less than 80°.

6. The thermal desalination system as recited in claim 1, the thermal desalination tower comprising at least one bubble cap tray.

7. The thermal desalination system as recited in claim 6, wherein the at least one bubble cap tray is disposed at an angle θ from horizontal which is greater than 0° and less than 80°.

8. The thermal desalination system as recited in claim 1, wherein the heat source is a power plant and waste heat from the power plant is used to heat the substance to produce the heated liquid.

9. The thermal desalination system as recited in claim 1, further comprising a liquid holding tank disposed in-line with the return path and between the thermal desalination tower and the heat source.

10. The thermal desalination system as recited in claim 1, further comprising a heat exchanger configured to receive the heated liquid and thereafter return the heated liquid to the heat source, the heat exchanger heating the raw water before the raw water is transferred to the thermal desalination tower.

11. The thermal desalination system as recited in claim 1, wherein the heat source is a solar heat source comprising at least one mirror that focuses sunlight on a pipe, the pipe containing the substance that is heated to produce the heated liquid.

12. A thermal desalination system comprising:
a heat source that heats a substance to produce a heated liquid;
a fluid path for transferring the heated liquid to a desalination device configured to receive the heated liquid;
a return path for transferring the heated liquid from the desalination device to the heat source;
a raw water source with raw water;
a raw water line that transfers the raw water from the raw water source to the desalination device, the desalination device configured to distill the raw water using heat from the heated liquid, thereby producing potable water;
a potable water tank for storing the potable water; and
wherein the desalination device comprises:
heating coils in thermal contact with a lower surface of an evaporation pan;
a raw water input port for receiving the raw water from the raw water line and transferring the raw water to the evaporation pan for subsequent evaporation to produce vaporized water;
an interior surface for condensing the vaporized water to produce distilled water;
a distilled water output port for receiving the distilled water and transferring the distilled water to the potable water tank.

13. The thermal desalination system as recited in claim 12, further comprising at least one gutter disposed within the desalination device such that the at least one gutter receives the distilled water from the interior surface.

14. The thermal desalination system as recited in claim 12, wherein the thermal desalination system comprises a plurality of the desalination devices connected in parallel.

15. The thermal desalination system as recited in claim 12, wherein the fluid path transfers the heated liquid to a fluid input of the desalination device such that the heated liquid circulates through the heating coils and out of a fluid output before being returned to the heat source.

16. A thermal desalination system comprising:
a heat source that heats a substance to produce a heated liquid;
a fluid path for transferring the heated liquid to a heat exchanger configured to receive the heated liquid;
a return path for transferring the heated liquid from the heat exchanger to the heat source;
a raw water source with raw water;
a raw water line that transfers the raw water from the raw water source to the heat exchanger, the heat exchanger configured to heat the raw water using heat from the heated liquid, thereby producing heated raw water;
a thermal desalination tower that receives the heated raw water and desalinate the heated raw water by distillation to produce potable water;
a potable water tank for storing the potable water; and
the thermal desalination tower comprising a lower distillation portion comprising:
a hot liquid jacket with a double-walled chamber that is disposed about a hollow cavity, the raw water being transferred to the hollow cavity through a raw water input port, the heated liquid entering the double-walled chamber through a fluid input and exiting through a fluid output, thereby heating the raw water in the hollow cavity to produce vaporized water;
an interior surface for condensing the vaporized water, thereby producing distilled water; and
at least one gutter disposed within the thermal desalination tower such that the at least one gutter receives the distilled water from the interior surface.

17. (canceled)

18. The thermal desalination system as recited in claim 16, wherein the heat source is a power plant and waste heat from the power plant is used to heat the substance to produce the heated liquid.

19. A thermal desalination system comprising:
a heat source that heats a substance to produce a heated liquid;
a fluid path for transferring the heated liquid to (1) a heat exchanger configured to receive the heated liquid and (2) a thermal desalination tower configured to receive the heated liquid;
a return path for transferring the heated liquid from the heat exchanger and the thermal desalination tower to the heat source;
a raw water source with raw water;
a raw water line that transfers the raw water from the raw water source to the heat exchanger, the heat exchanger configured to heat the raw water using heat from the heated liquid, thereby producing heated raw water;
the thermal desalination tower configured to receive the heated raw water and desalinate the heated raw water by distillation, using the heat from the heated liquid, to produce potable water;
a potable water tank for storing the potable water, and
the thermal desalination tower comprising a lower distillation portion comprising:
a hot liquid jacket with a double-walled chamber that is disposed about a hollow cavity, the raw water being transferred to the hollow cavity through a raw water input port, the heated liquid entering the double-walled chamber through a fluid input and exiting through a fluid output, thereby heating the raw water in the hollow cavity to produce vaporized water;
an interior surface for condensing the vaporized water, thereby producing distilled water; and
at least one gutter disposed within the thermal desalination tower such that the at least one gutter receives the distilled water from the interior surface.

20. The thermal desalination system as recited in claim 19, wherein the heat source is a power plant and waste heat from the power plant is used to heat the substance to produce the heated liquid.
